(19) United States
(12) Patent Application Publication
(10) Pub. No.: US 2013/0239344 A1
(43) Pub. Date: Sep. 19, 2013

(54) DRY WIPES COMPRISING MICROENCAPSULATED CLEANING COMPOSITION

(71) Applicant: P.H. GLATFELTER COMPANY, York, PA (US)

(72) Inventors: John W. Stolarz, JR., Circleville, OH (US); James Gregory Lovensheimer, Chillicothe, OH (US)

(73) Assignee: P.H. Glatfelter Company, York, PA (US)

(21) Appl. No.: 13/837,269

(22) Filed: Mar. 15, 2013

Related U.S. Application Data
(60) Provisional application No. 61/612,457, filed on Mar. 19, 2012.

(51) Int. Cl. C11D 17/04; B65D 85/16

(52) U.S. Cl. CPC C11D 17/049; B65D 85/16
USPC 15/104.93; 206/494

(57) ABSTRACT

A dry wipe for cleaning an article or surface comprising: a non-woven fibrous substrate pre-loaded with microcapsules containing a cleaning composition.

### CROSS-REFERENCE TO RELATED APPLICATIONS

This application claims the benefit of priority under 35 U.S.C. §119(e) to earlier filed U.S. patent application Ser. No. 61/612,457, filed on Mar. 19, 2012, the disclosure of which is incorporated herein by reference in its entirety.

### BACKGROUND OF THE INVENTION

The present invention relates to a dry wipe composition comprising a microencapsulated cleaning composition. The dry wipes of the present invention retain their cleaning ability until the time of use even when exposed to air for an extended period of time.

A variety of liquid and solid or semi-solid ingredients have been deposited onto various forms of substrates for a variety of purposes. Typically, the substrates are wipes, formed of either a woven or non-woven material, and containing a liquid active composition. In one form, a non-woven material is soaked in a liquid cleaning active, and packaged in a canister. Examples are disposable cleaning wipes marketed for personal hygiene or household cleaning products sold and by a variety of manufacturers.

Cleaning wipes, for example, have long been used for a variety of purposes. Such cleaning wipes have contained various compounds to accomplish their intended purpose. Cleaning wipes have included soaps and detergents to clean hard surfaces such as tiles, ceramics, counter tops, floors, and the like, as well soft surfaces such as fabrics and upholstery. Wipes also have been formulated with personal care products, for example to clean an individual's hands. Still further, cleaning wipes have included ammonia to clean glass surfaces. Alcohol and various other biocides have been included on cleaning wipes to disinfect a variety of surfaces. Cleaning wipes have also included waxes to polish and clean furniture.

All of the foregoing examples, however, are limited to wet applications wherein the wipes are saturated with the cleaning solution. When exposed to the air such as, for example, when a dispensing container is left open for too long, the wipes dry out and become ineffective for their intended application even when re-wetted.

Accordingly, there is a need in the art for a dry substrate wipe comprising, for example, an active cleaning agent that can effectively activate and deliver the cleaning agent at the time of use.

### DETAILED DESCRIPTION OF THE INVENTION

All publications, patents and patent applications cited herein are hereby incorporated by reference in their entirety to the same extent as if each individual publication, patent or patent application was specifically and individually indicated to be incorporated by reference.

### Definitions

As used herein, the terms “fibrous substrate” or “wipe” are intended to include any material onto and/or into which microencapsulated cleaning compositions according to the present invention may be loaded. In functional application, a substrate is used to clean an article or a surface (including skin), as by wiping. Substrates may comprise woven or non-woven materials, typically made from a plurality of fibers, films and similar materials onto which cleaning compositions can be loaded as described herein. The substrate can be used by itself (typically by hand) or attached to a cleaning implement, such as a floor mop, handle, or a hand held cleaning tool such as, for example, a toilet cleaning device.

“Cleaning composition” as used herein, is a fluid or solid composition used for cleaning hard and/or soft surfaces. Cleaning means any treatment of a surface which serves to remove or reduce unwanted or harmful materials such as soil, dirt or microbial contamination from a surface, and/or which imparts a desirable or beneficial aesthetic, health or safety effect to the surface such as depositing thereon a fragrance, color or protective coating or film. Cleaning also includes, for example, removal of makeup from a wearer's skin.

As used herein, the terms “microencapsulated cleaning composition” or “microcapsules” refer to a cleaning composition as described herein refer to small particles with sizes between 1 and 2,500 μm that contain within cleaning compositions according to the present invention surrounded by a natural or, preferably, a synthetic polymeric membrane. Such encapsulation is typically employed, for example, protect fragrances or other active agents from oxidation or to control the evaporation of such substances. The encapsulated agent can be released by many actions (depending on the composition of the shell), including mechanical, temperature, diffusion, pH, biodegradation, and dissolution means.

As used herein, the term “dry wipe” means a wipe that includes less than about 10% (by weight substrate) moisture content. Specifically, suitable wipes for use in the present disclosure can include hand wipes, face wipes, cosmetic wipes, household wipes, industrial wipes, and the like. In contrast, a “wet wipe” is a wipe that includes greater than about 70% (by weight substrate) moisture content.

“Pre-loaded wipes” as used herein, are dry wipes according to the present invention which include microcapsules of cleaning composition prior to use by the consumer. “Pre-loaded wipes” as used herein, may include dry wipes that are impregnated with liquid containing the microcapsules and dried prior to packaging. “Pre-loaded” wipes can include at least one later (e.g., external or internal) of microencapsulated cleaning composition or can include microcapsules impregnated and dispersed throughout the substrate or wipe. Such impregnation is described in more detail below.

As used herein, the term “nonwoven fabric or web” means a web having a structure of individual fibers or threads which are interlaid, but not in a regular or identifiable manner as in a knitted fabric. The term also includes individual filaments and strands, yarns or tows as well as foams and films that have been fibrillated, apertured, or otherwise treated to impart fabric-like properties. Nonwoven fabrics or webs have been formed from many processes such as for example, melt blowing processes, spunbonding processes, airlaying processes and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein, the term “basis weight” means the weight per unit area of the substrate or wipe. One method of determining basis weight, therefore, is to weigh a known area sample that is representative of the wipe or substrate.

As used herein, the term “fiber” refers to a thread-like object or structure from which textiles and non-woven fabrics are commonly made. The term “fiber” is meant to encompass both continuous and discontinuous filaments, and other thread-like structures having a length that is substantially greater than its diameter.

“Airlaying” or “air-layed web” is a well-known process by which a fibrous nonwoven layer can be formed. In the airlaying process, bundles of small fibers are separated and entrained in an air supply and then deposited onto a forming screen, usually with the assistance of a vacuum supply. The randomly deposited fibers then are bonded to one another using, for example, hot air or a spray adhesive. Such fibers may have lengths of up to 50 millimeters.

As used herein, the term “polymeric” includes, but is not limited to, homopolymers, copolymers, such as for example, block, graft, random and alternating copolymers, terpolymers, etc. and blends and modifications thereof.

### Microcapsules and Core

The microencapsulated cleaning compositions described herein are desirably of a size such that, when incorporated into a dry wipe, they cannot readily be felt on the skin by the user. Preferably, the microcapsules have a diameter of from about 1 μm to about 2,500 μm, more preferably from about 1 μm to about 1,000 μm, still more preferably from about 1 μm to about 150 μm, and even more preferably from about 5 μm to about 70 μm.

The core composition includes all of the components or materials that are encapsulated as described herein by, for example, a cross-linked polymeric system, to form the microencapsulated delivery vehicles. The core composition comprises the cleaning composition. The cleaning composition preferably comprises a liquid oil-type substance such as, for example, aromatic hydrocarbons and terpene oils. Terpene oils are preferred.

Terpene oils that may be microencapsulated for use according to the present invention are preferably the mono- and bicyclic monoterpenes, i.e., those of the hydrocarbon class, which include, for example, the terpinenes, terpinolenes, limonenes, pinenes and mixtures thereof. Particularly preferred terpenes include d-limonene, limonese, dipentene, alpha-pinene, beta-pinene, the mixture of terpene hydrocarbons obtained from the essence of oranges, e.g., cold-pressed orange terpenes and orange terpene oil phase ex fruit juice, and the mixture of terpene hydrocarbons expressed from lemons and grapefruit. The foregoing terpene hydrocarbon oils are derivatives of pine tree products or citrus by-products and, therefore, are naturally occurring materials. Numerous other terpene hydrocarbons are known to those skilled in the art and may be used as all or part of the cleaning compositions to be microencapsulated for use according to the present invention; however, those mentioned above are the most readily available and, hence, are preferred. Such materials may also be formulated with up to 50% of auxiliary materials, such as stabilizers, e.g., antioxidants such as butylated hydroxytoluene, and such auxiliary materials are included within the meaning of the term “terpene oil” or “terpene solvent”, as employed in this specification and the accompanying claims.

D-limonene is highly preferred as the encapsulated core cleaning composition of the present invention. It is derived from distilled orange rind oil and may be obtained in essentially pure form from citrus products companies which produce it as a by-product.

In preferred embodiments, the cleaning composition is in a liquid phase at room temperature.

Depending on the application, however, the core may comprise other suitable oils including mineral oil, baby oil, vegetable oils, avocado oil, jojoba oil, borage oil, canola oil, castor oil, chamomile, coconut oil, corn oil, cottonseed oil, evening primrose oil, safflower oil, sunflower oil, soybean oil, sweet almond, lanolin, partially hydrogenated vegetable oils. For example, if the application is a personal hygiene application such as, for example, makeup removal, the it would be preferable that the core comprises, for example, coconut oil or a vegetable oil that would be less harmful to a person's skin.

In another embodiment, the core may comprise N,N-Diethyl-meta-toluamide, abbreviated “DEET,” which is employed as a mosquito repellant. Other oils may be included with the DEET in the core to add scent such as, for example, any of the citrus oils detailed above.

Generally, the core composition is present in the microcapsule in an amount of from about 0.1% (by weight) to about 99.99% (by weight), desirably from about 1% (by weight) to about 95% (by weight), more desirably from about 5% (by weight) to about 90% (by weight), more desirably from about 10% (by weight) to about 80% (by weight), more desirably from about 15% (by weight) to about 70% (by weight), and even more desirably from about 20% (by weight) to about 40% (by weight).

The core cleaning compositions of the present disclosure may also optionally contain a variety of other components which may assist in providing the desired cleaning properties. For example, additional components may include non-antagonistic emollients, surfactants, preservatives, chelating agents, pH adjusting agents, fragrances, moisturizing agents, skin benefit agents (e.g., aloe and vitamin E), antimicrobial actives, acids, alcohols, or combinations or mixtures thereof. The composition may also contain lotions, and/or medicaments to deliver any number of cosmetic and/or drug ingredients to improve performance.

A number of microencapsulation techniques known to those skilled in the art (e.g., interfacial polymerization, “in situ” polymerization, coacervation, etc.) can be employed to form an encapsulation layer or “shell” around the cleaning composition thereby creating a “core” where the cleaning composition resides. The selection of the technique and shell material depends on the final application of the product, considering physical and chemical stability, concentration, desired particle size, release mechanism, and manufacturing costs. Preferably a cross-linking polymerization reaction between a cross-linkable component and an activator compound is employed in an emulsion environment. Interfacial cross-linking polymerization techniques well known to those skilled in the art are particularly preferred in the present invention. Such systems include gelatin, formaldehyde systems (phenol-formaldehyde or melamine-formaldehyde resins) and polyurethane-urea systems. Polyurethane-urea systems are particularly preferred for encapsulating the cleaning compositions according to the present invention. Preferred polyurethane-urea systems according to the present invention include, for example, the reaction of diisocyanates such as, for example, hexamethylene diisocyanate with a cross-linking activator compound such as, for example, polyethylene glycol or polyvinyl alcohol. A preferred microencapsulation procedure is disclosed by Rodrigues et al., Microencapsulation of Limonene for Textile Application, Ind. Eng. Chem. Res., 2008, 47, 4142-4147, which is incorporated herein by reference in its entirety. Another preferred microencapsulation procedure is disclosed in U.S. Pat. No. 5,635,211, which is incorporated herein by reference in its entirety.

### Fibrous Substrate

Materials suitable for the fibrous substrate of the dry wipes according to the present invention are well known to those skilled in the art, and are typically made from a fibrous sheet material which may be either woven or nonwoven. For example, suitable materials for use in the wipes may include nonwoven fibrous sheet materials which include meltblown, co-form, air-layed, bonded-carded web materials, hydroentangled materials, and combinations thereof. Such materials can be comprised of synthetic or natural fibers, or a combination thereof.

The fibers may comprise natural fibers, synthetic fibers, polypropylene, polyethylene, polyester, PET, wood pulp, regenerated cellulose, nylon, cotton, bicomponent fibers, continuous fibers, and combinations thereof including blends or a layers of one or more of the above fibers. In some embodiments of the present invention, the fibrous web or substrate comprises fibers with a denier of about 0.3 to 10.

Suitable thermoplastic fibers can be made from a single polymer (monocomponent fibers), or can be made from more than one polymer (e.g., bicomponent or multicomponent fibers). Multicomponent fibers are described in U.S. Pat. App. 2003/0106568. Bicomponent fibers are described in U.S. Pat. No. 6,613,704. Multicomponent fibers of a wide range of denier or dtex are described in U.S. Pat. App. 2002/0106478.

As used herein, the term “bicomponent fibers” refers to fibers formed from at least two different polymers extruded from separate extruders but spun together to form one fiber. Bicomponent fibers are also sometimes referred to as conjugate fibers or multicomponent fibers. The polymers are arranged in substantially constantly positioned distinct zones across the cross-section of the bicomponent fibers and extend continuously along the length of the bicomponent fibers. The configuration of such a bicomponent fiber may be, for example, a sheath/core arrangement wherein one polymer is surrounded by another, or may be a side-by-side arrangement, a pie arrangement, or an “islands-in-the-sea” arrangement, each as is known in the art of multicomponent, including bicomponent, fibers.

The “bicomponent fibers” may be thermoplastic fibers that comprise a core fiber made from one polymer that is encased within a thermoplastic sheath made from a different polymer or have a side-by-side arrangement of different thermoplastic fibers. The first polymer often melts at a different, typically lower, temperature than the second polymer. In the sheath/core arrangement, these bicomponent fibers provide thermal bonding due to melting of the sheath polymer, while retaining the desirable strength characteristics of the core polymer. In the side-by-side arrangement, the fibers shrink and crimp creating z-direction expansion.

Bicomponent fibers can be splittable fibers, such fibers being capable of being split lengthwise before or during processing into multiple fibers each having a smaller cross-sectional dimension than the original bicomponent fiber. Splittable fibers have been shown to produce softer nonwoven webs due to their reduced cross-sectional dimensions. Representative splittable fibers useful in the present invention include type T-502 and T-512 16 segment PET/nylon 6 2.5 denier fibers; and type T-522 16 segment PET/PP splittable fibers, all available from Fiber Innovation Technology, Johnson City, Tenn.

Suitable bicomponent fibers for use in the present invention can include sheath/core or side-by-side fibers having the following polymer combinations: polyethylene/polypropylene, polyethylvinyl acetate/polypropylene, polyethylene/polyester, polypropylene/polyester, copolyester/polyester, and the like. Particularly suitable bicomponent thermoplastic fibers for use herein are those having a polypropylene or polyester core, and a lower melting copolyester, polyethylvinyl acetate or polyethylene sheath (e.g., those available from Danaklon a/s, Chisso Corp., and CELBOND®, available from Hercules). These bicomponent fibers can be concentric or eccentric. As used herein, the terms “concentric” and “eccentric” refer to whether the sheath has a thickness that is even, or uneven, through the cross-sectional area of the bicomponent fiber. Eccentric bicomponent fibers can be desirable in providing more compressive strength at lower fiber thicknesses.

In a preferred embodiment of the invention, the fibers in the substrate can be comprised of hydrophilic fibers or a combination of both hydrophilic and hydrophobic fibers. Suitable hydrophilic fibers for use in the present invention include cellulosic fibers, modified cellulosic fibers, rayon, cotton, and polyester fibers, such as hydrophilic nylon (HYDROFIL®). Suitable hydrophilic fibers can also be obtained by hydrophilizing hydrophobic fibers, such as surfactant-treated or silica-treated thermoplastic fibers derived from, for example, polyolefins such as polyethylene or polypropylene, polyacrylics, polyamides, polystyrenes, polyurethanes and the like.

Pre-Loading/ Impregnating the Fibrous Substrate with Microcapsules

The microcapsules of the present invention can be applied to the dry wipe using any means known to one skilled in the art. Preferably, the microcapsules are embedded between the fibers of the fibrous substrate of the wipe.

In one embodiment, the microcapsules are embedded inside of the fibrous substrate (i.e., between the fibers). For example, the fibrous substrate can be a co-form basesheet comprising a matrix of thermoplastic polymeric meltblown fibers and absorbent cellulosic fibers. When the fibrous substrate is a matrix of thermoplastic polymeric meltblown fibers and absorbent cellulosic fibers, a stream of microcapsules can be merged with a stream of cellulosic fibers and a stream of polymeric fibers into a single stream and collected on a forming surface such as a forming belt or forming drum to form a wipe comprising a fibrous substrate with the microencapsulated cleaning compositions within its core.

The stream of absorbent cellulosic fibers may be provided by feeding a pulp sheet into a fiberizer, hammermill, or similar device as is known in the art. An air-layed process is particularly prefered for forming a substrate of such fibers.

The thickness of the fibrous substrate will typically depend upon the diameter size of the microcapsules, the fibrous substrate basis weight, and the microcapsule loading. For example, as the size of the microcapsules is increased, the fibrous substrate must be thicker to prevent the wipe from having a gritty feel.

In another embodiment, the fibrous substrate is made up of more than one layer. For example, when the fibrous substrate is a meltblown material, the fibrous substrate can suitably be made up of two meltblown layers secured together, more suitably three meltblown layers, even more suitably four meltblown layers, and even more suitably five or more meltblown layers. When the fibrous substrate is a coform basesheet, the fibrous substrate can suitably be made up of two coform basesheet layers secured together, more suitably three coform basesheet layers, even more suitably four coform basesheet layers, even more suitably five or more coform basesheet layers. Moreover, when the fibrous substrate includes a film, the fibrous substrate can suitably be made up of two film layers, more suitably three film layers, even more suitably four film layers, and even more suitably five or more film layers. In one embodiment, the layers are separate layers. In another embodiment, the layers are plied together.

Using the additional layers will allow for improved capture of the microcapsules. This helps to ensure the microcapsules will remain in the wipe during shipping and storage. Additionally, as the microcapsules become further entrapped in the fibrous substrate, the grittiness of the wipe is reduced.

To incorporate the microcapsules in between the layers of fibrous sheet material, the microcapsules can be sandwiched between a first layer and a second layer of the fibrous substrate, and the layers are then laminated together using any means known in the art. For example, the layers can be secured together thermally or by a suitable laminating adhesive composition.

Thermal bonding includes continuous or discontinuous bonding using a heated roll. Point bonding is one suitable example of such a technique. Thermal bonds should also be understood to include various ultrasonic, microwave, and other bonding methods wherein the heat is generated in the non-woven or the film.

In a preferred embodiment, the first layer and second layer are laminated together using a water insoluble adhesive composition. Suitable water insoluble adhesive compositions can include hot melt adhesives and latex adhesives as described in U.S. Pat. Nos. 6,550,633; 6,838,154; and 6,958,103, which are hereby incorporated by reference. Suitable hot melt adhesives can include, for example, RT 2730 APAO and RT 2715 APAO, which are amorphous polyalphaolefin adhesives (commercially available from Huntsman Polymers Corporation, Odessa, Tex.) and H2800, H2727A, and H2525A, which are all styrenic block copolymers (commercially available from Bostik Findley, Inc., Wauwatosa, Wis.). Suitable latex adhesives include, for example, DUR-O-SET E-200 (commercially available from National Starch and Chemical Co., Ltd., Bridgewater, N.J.) and Hycar 26684 (commercially available from B. F. Goodrich, Laval, Quebec).

The water insoluble adhesive composition can additionally be used in combination with the microcapsules between the first and second layers of the fibrous substrate. The water insoluble adhesive composition will provide improved binding of the microcapsules to the first and second layers of the fibrous substrate. Typically, the adhesive composition can be applied to the desired area by spraying, knifing, roller coating, or any other means suitable in the art for applying adhesive compositions.

Suitably, the adhesive composition can be applied to the desired area of the wipe in an amount of from about 0.01 grams per square meter to about 25 grams per square meter. More suitably, the adhesive composition can be applied in an amount of from about 0.05 grams per square meter to about 0.5 grams per square meter.

As an alternative to embedding the microcapsules into the core of the fibrous substrate, the microcapsules can be coated on the outer surface of the fibrous substrate. In one embodiment, the microcapsules are deposited on one outer surface of the fibrous substrate. In another embodiment, the microcapsules are deposited on both outer surfaces of the fibrous sheet material.

To provide for better attachment of the microcapsules to the outer surface of the fibrous sheet material, a water insoluble adhesive composition can be applied with the microcapsules onto the outer surface of the fibrous sheet material. Suitable water insoluble adhesive compositions are described herein above. Suitably, the adhesive composition can be applied to the outer surface of the fibrous substrate in an amount of from about 0.01 grams per square meter to about 25 grams per square meter. More suitably, the adhesive composition can be applied in an amount of from about 0.05 grams per square meter to about 0.5 grams per square meter.

In some embodiments of the present invention, the microcapsules may be colored using a coloring agent prior to applying the microcapsules to the fibrous substrate. The coloring of the microcapsules can improve the aesthetics of the wipe.

Suitable coloring agents include, for example, dyes, color additives, and pigments or lakes. Suitable dyes include, for example, Blue 1, Blue 4, Brown 1, External Violet 2, External Violet 7, Green 3, Green 5, Green 8, Orange 4, Orange 5, Orange 10, Orange 11, Red 4, Red 6, Red 7, Red 17, Red 21, Red 22, Red 27, Red 28, Red 30, Red 31, Red 33, Red 34, Red 36, Red 40, Violet 2, Yellow 5, Yellow 6, Yellow 7, Yellow 8, Yellow 10, Yellow 11, Acid Red 195, Anthocyanins, Beetroot Red, Bromocresol Green, Bromothymol Blue, Capsanthin/Capsorubin, Curcumin, and Lactoflavin. Also, many dyes found suitable for use in the European Union and in Japan may be suitable for use as coloring agents in the present disclosure.

Suitable color additives include, for example, aluminum powder, annatto, bismuth citrate, bismuth oxychloride, bronze powder, caramel, carmine, beta carotene, chloraphyllin-copper complex, chromium hydroxide green, chromium oxide greens, copper powder, disodium EDTA-copper, ferric ammonium ferrocyanide, ferric ferrocyanide, guauazulene, guanine, henna, iron oxides, lead acetate, manganese violet, mica, pyrophylite, silver, titanium dioxide, ultramarines, zinc oxide, and combinations thereof.

Suitable pigments or lakes include, for example, Blue 1 Lake, External Yellow 7 Lake, Green 3 Lake, Orange 4 Lake, Orange 5 Lake, Orange 10 Lake, Red 4 Lake, Red 6 Lake, Red 7 Lake, Red 21 Lake, Red 22 Lake, Red 27 Lake, Red 28 Lake, Red 30 Lake, Red 31 Lake, Red 33 Lake, Red 36 Lake, Red 40 Lake, Yellow 5 Lake, Yellow 6 Lake, Yellow 7 Lake, Yellow 10 Lake, and combinations thereof.

### Base Weight

The base weight of the dry wipes according to the present invention will depend on the intended application, which there are many.

Typically, the wipes of the present disclosure define a basis weight of from about 10 grams per square meter to about 300 grams per square meter and desirably from about 20 grams per square meter to about 150 grams per square meter, and more desirably from about 80 grams per square meter to about 100 grams per square meter.

For applications requiring light base weights, the wipes of the present disclosure define a basis weight of from about 10 grams per square meter to about 30 grams per square meter and desirably from about 12 grams per square meter to about 20 grams per square meter, and more desirably from about 12 grams per square meter to about 15 grams per square meter.

Dry wipes of the present invention may also comprise fiber glass and paper board fibers, which would tend to shift the base weight on the higher end of the range.

In one particular embodiment, the wipes of the present disclosure comprise a coform basesheet of polymer fibers and absorbent fibers having a basis weight of from about 60 to about 80 grams per square meter and desirably about 75 grams per square meter. Such coform basesheets are manufactured generally as described in U.S. Pat. Nos. 4,100,324; 5,284,703; and 5,350,624, which are incorporated by reference to the extent to which they are consistent herewith. Typically, such coform basesheets comprise a gas-formed matrix of thermoplastic polymeric meltblown fibers and cellulosic fibers. Various suitable materials may be used to provide the polymeric meltblown fibers, such as, for example, polypropylene microfibers. Alternatively, the polymeric meltblown fibers may be elastomeric polymer fibers, such as those provided by a polymer resin. For instance, Vistamaxx® elastic olefin copolymer resin designated PLTD-1810, available from ExxonMobil Corporation (Houston, Tex.) or KRATON G®-2755, available from Kraton Polymers (Houston, Tex.) may be used to provide stretchable polymeric meltblown fibers for the coform basesheets. Other suitable polymeric materials or combinations thereof may alternatively be utilized as known in the art.

As noted above, the coform basesheet additionally may comprise various absorbent cellulosic fibers, such as, for example, wood pulp fibers. Suitable commercially available cellulosic fibers for use in the coform basesheets can include, for example, NF 405, which is a chemically treated bleached southern softwood Kraft pulp, available from Weyerhaeuser Co. of Federal Way (Wash.); NB 416, which is a bleached southern softwood Kraft pulp, available from Weyerhaeuser Co.; CR-0056, which is a fully debonded softwood pulp, available from Bowater, Inc. (Greenville, S.C.); Golden Isles 4822 debonded softwood pulp, available from Koch Cellulose (Brunswick, Ga.); and SULPHATATE HJ, which is a chemically modified hardwood pulp, available from Rayonier, Inc. (Jesup, Ga.).

The relative percentages of the polymeric meltblown fibers and cellulosic fibers in the coform basesheet can vary over a wide range depending upon the desired characteristics of the wipes. For example, the coform basesheet may comprise from about 10 weight percent to about 90 weight percent, desirably from about 20 weight percent to about 60 weight percent, and more desirably from about 25 weight percent to about 35 weight percent of the polymeric meltblown fibers based on the dry weight of the coform basesheet being used to provide the wipes.

### Applications

To use the dry wipes according to the present invention, any means known to one of skill in the art capable of producing sufficient force to break the capsules can be used in the present disclosure. In one embodiment, the microcapsules can be broken by the user at the point of dispensing the wipe from a package. For example, a mechanical device located inside of the package dispenser containing the wipes can produce a rupture force sufficient to rupture the capsules upon dispensing the wipe, thereby exposing the contents of the microencapsulated heat delivery vehicles.

In another embodiment, the capsules can be broken by the user just prior to or at the point of use of the wipe. By way of example, in one embodiment, the force produced by the hands of the user of the wipe can break the capsules, exposing the contents of the microencapsulated heat delivery vehicles.

Applications suitable for employment of the present invention include, for example, cleaning household or industrial articles or surfaces (where, for example, d-limonene may be the core material); removal of makeup or application of skin care oils (where, for example, coco butter or baby oil may be the core material); brass cleaning/polishing dry wipes; shoe polish dry wipes; car polish; and stainless steel polish.

The dry wipes of the present invention may also comprise additives suitable for the intended purpose such as, for example, abrasives, antibacterial agents, etc.

The dry wipes of the present invention may also comprise surfaces with differing functions. For example, one surface may comprise microencapsulated cleaning compositions and the other surface may comprise, for example, abrasive particles.

The dry wipes of the present invention retain their cleaning ability until the time of use.

In another embodiment, a dry substrate may have incorporated therein microcapsules comprising a core comprising N,N-Diethyl-meta-toluamide (“DEET”), for use in delivering mosquito repellant in, for example, a dry wipe application. If the substrate is large, it could also be employed as a picinic table cloth which would have the propert of keeping mosquitoes and other flying insects away from the table.

The present invention is illustrated by the following examples which are merely for the purpose of illustration and are not to be regarded as limiting the scope of the invention or manner in which it may be practiced.

### EXAMPLES

Determination of coating weight of D-Limonene Microcapsules

A monolayer of microcapsule is preferred as it is believed to deliver measured micro dose of cleaner with fast evaporation leaving little or no residue. Weight of a monolayer is calculated and transferred to slurry weight.

Coulter measurement of capsules: 25 microns
Theoretical wall thickness of 20% wall capsules 0.74 microns
1. Theoretical capsules per sq centimeter
1 capsule occupies 625 microns (25×25)
1 sq inch=645,160,000 sq microns
122,254,059 capsules/ gram theoretical calculation by volume
Mono layer of capsules=645,160,000 sq microns per sq inch/625 sq microns/capsule=1, 0323,256 capsules/sq inch

2. Coating weight @ 100 solids
122,254,059 capsules /gram theoretical calculation by volume
Grams of capsules req.=1,032,256 (capsules per sq inch)/122,254,059 capsules per gram=0.00844 grams per sq in.

3. Coating weight @ 35% solids
100%/35%×0.00844=0.0241 GRAMS PER SQ INCH FOR MONOLAYER OF CAPSULES

4. Blue shop towels (5.5×11.5)×0.0241 grams per sq inch=1.35 grams of slurry

### Lab Procedure and Evaluation of Coated Towel

### Coating

Polyurea microencapsulated d-limonene was diluted 9 to 1 with water and sprayed onto various cloth materials. Blue commercial grade lab wipes were cut to 5.5×11.5 strips and prepared for coating. Towels were laid on a flat hard surface and fixed with fasteners to hold it in place. A standard 1 quart commercial trigger spray bottle was charged with 15 grams of dilute capsule solution. The entire solution was sprayed on the towels in an even coat. The towels were weighed to determine the placement of 13.5 grams of dilute solution. Samples were allowed to rest for 5 minutes to allow the excess water and capsules to fully absorb into the towels. Towels were then oven dried at 212° F. in a forced air oven. Result was a dry towel with no oily residue and a slight orange aroma.

Process was repeated with substituting Swifter® mop pads by P&G as the towel substrate.

### Sensory Evaluation

The towels were tested for grease removal capability. White grease was placed on a shiny metallic surface and coated and uncoated wipes were used to clean the surfaces. Samples were then observed visually for residual grease or chemicals. Uncoated wipes consistently left a visible oily film on the shiny metallic surface. Wipes created with the d-limonene microcapsules/dry wipes according to the present invention consistently cleaned the surface with no chemical residue. There was a slight orange aroma. Sample will easily pass a double blind study.

Both capsule coated Swifter® and capsule coated generic lab towels performed great in this test. And each sample greatly outperformed the uncoated control samples.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

1. A dry wipe for cleaning an article or surface comprising:
a non-woven fibrous substrate pre-loaded with microcapsules having a diameter of from about 1μ to about 2500μ, wherein the microcapsules comprise a cross-linked polymer shell and a core surrounded by the shell, wherein the core comprises a fragrant oil, and wherein the substrate has a moisture content of less than about 10%.

2. The dry wipe of claim 1 wherein the cross-linked polymer shell is selected from the group consisting of phenol-formaldehyde resin, melamine-formaldehyde resin, polyurethane-urea resin, and gelatin.

3. The dry wipe of claim 2 wherein the fragrant oil is a terpene oil.

4. The dry wipe of claim 3 wherein the terpene oil is selected from the group consisting of terpinenes, terpinolenes, limonenes, pinenes, and mixtures thereof.

5. The dry wipe of claim 3 wherein the terpene oil is selected from the group consisting of d-limonene, limonese, dipentene, alpha-pinene, beta-pinene, orange terpene, and mixtures thereof.

6. The dry wipe according to claim 3 wherein the fragrant oil is D-limonene.

7. The dry wipe according to claim 3 wherein the fragrant oil is selected from the group consisting of mineral oil, baby oil, vegetable oils, avocado oil, borage oil, canola oil, castor oil, chamomile, coconut oil, corn oil, cottonseed oil, evening primrose oil, safflower oil, sunflower oil, soybean oil, sweet almond, lanolin, and partially hydrogenated vegetable oils.

8. The dry wipe of claim 2 wherein the cross-linked polymer shell is a polyurethane-urea resin.

9. The dry wipe of claim 1 wherein the diameter of the microcapsules is from about 1μ to about 1000μ.

10. The dry wipe of claim 9 wherein the diameter of the microcapsules is from about 1μ to about 150μ.

11. The dry wipe of claim 10 wherein the diameter of the microcapsules is from about 5μ to about 70μ.

12. The dry wipe of claim 1 wherein the core is present in the microcapsule in an amount of from about 0.1% to about 99.99%.

13. The dry wipe of claim 12 wherein the core is present in the microcapsule in an amount of from about 10% to about 80%.

14. The dry wipe of claim 13 wherein the core is present in the microcapsule in an amount of from about 20% to about 40%.

15. The dry wipe of claim 1 wherein the fibrous substrate is an air layed web.

16. The dry wipe of claim 15 wherein the substrate comprises fibers selected from the group consisting of natural fibers, synthetic fibers, polypropylene, polyethylene, polyester, PET, wood pulp, regenerated cellulose, nylon, cotton, bicomponent fibers, continuous fibers, and combinations thereof including blends or a layers of one or more of the above fibers.

17. The dry wipe of claim 15 wherein the fibrous substrate is a multi-layer substrate.

18. The dry wipe of claim 17 wherein the microcapsules are incorporated into the wipe between the layers.

19. A dispenser comprising multiple dry wipes according to claim 1.

20. A method of cleaning or polishing an article or surface, the method comprising the step of contacting the article or surface with a non-woven fibrous substrate pre-loaded with microcapsules containing a fragrance oil such that the microcapsules break with force of contact and release fragrance oil.

21. A non-woven fibrous substrate pre-loaded with microcapsules having a diameter of from about 1μ to about 2500μ, wherein the microcapsules comprise a cross-linked polymer shell and a core surrounded by the shell, wherein the core comprises N,N-Diethyl-meta-toluamide, and optionally a fragrant oil, and wherein the substrate has a moisture content of less than about 10%.
